(19) United States
(12) Patent Application Publication
(10) Pub. No.: US 2026/0171291 A1
(43) Pub. Date: Jun. 18, 2026

(54) MAGNETIC UNIT

(71) Applicant: Yazaki Corporation, Tokyo (JP)

(72) Inventors: Masayo MATSUURA, Shizuoka (JP); Takuto MISHIGE, Shizuoka (JP); Kenji SEGAWA, Shizuoka (JP); Takanori KANAMORI, Shizuoka (JP); Junya ISHIDA, Shizuoka (JP)

(73) Assignee: Yazaki Corporation, Tokyo (JP)

(21) Appl. No.: 19/419,438

(22) Filed: Dec. 15, 2025

(30) Foreign Application Priority Data
Dec. 16, 2024 (JP) 2024-219696

(51) Int. Cl. H01F 7/06

(52) U.S. Cl. CPC H01F 7/06

(57) ABSTRACT

A magnetic unit includes: a magnetic core formed in an annular shape about a first direction and including a first core and a second core split along a second direction, in which the first core and the second core are in contact with each other along a third direction; a plate spring configured to energize the second core toward the first core along the third direction; a cover including a one-side locking part to which a leg part of the plate spring is locked; a base member that accommodates the magnetic core and includes a bottom part that supports the first core, a cover guide part that guides the cover entering along the third direction, and an other-side locking part to which a leg part of the plate spring is locked; and a lock part that locks the cover and the base member to each other.

### CROSS-REFERENCE TO RELATED APPLICATION(S)

The present application claims priority to and incorporates by reference the entire contents of Japanese Patent Application No. 2024-219696 filed in Japan on Dec. 16, 2024.

### BACKGROUND OF THE INVENTION

### 1. Field of the Invention

The present invention relates to a magnetic unit.

### 2. Description of the Related Art

In one example of the conventional art regarding a magnetic unit according to Japanese Patent Application Laid-open No. 2014-160737, a core includes split core pieces that are separated along a first axis direction among a first axis, a second axis, and a third axis that are perpendicular to each other. To a case, a spring member that presses the slit core pieces downward along the third axis in the case is attached. In the spring member, a slit is formed along a second axis direction. A first pressing piece and a second pressing piece are formed. In the first pressing piece and the second pressing piece, elastic bending parts in contact with the respective split core pieces are formed displaced along the second axis direction. The spring member is fixed to the case with a fixing bolt through a fixing hole provided in the spring member.

Incidentally, such a magnetic unit includes an energizing member such as a spring member in order to bring the split magnetic cores in contact with each other, for example. There is room for further improvement in the configuration for assembling the energizing member to the case.

### SUMMARY OF THE INVENTION

The present invention is made in view of such a situation, and provides a magnetic unit according that the energizing member to energize the magnetic core can be properly assembled.

In order to achieve the above mentioned object, a magnetic unit according to one aspect of the present invention includes a magnetic core formed in an annular shape about a first direction and including a first core and a second core split along a second direction that intersects with the first direction, in which the first core and the second core are in contact with each other along a third direction that intersects with the first direction and the second direction; an energizing member configured to energize the second core toward the first core along the third direction; a cover including a one-side locking part to which one side of the energizing member is locked; a base member that accommodates the magnetic core and includes a bottom part that supports the first core, a cover guide part that guides the cover entering along the third direction, and an other-side locking part to which the other side of the energizing member is locked; and a lock part that locks the cover and the base member to each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a magnetic unit according to an embodiment;

FIG. 2 is an exploded perspective view illustrating the magnetic unit according to the embodiment;

FIG. 3 is a perspective view illustrating a base member according to the embodiment;

FIG. 4 is a cross-sectional perspective view around a lock part, which is taken along IV-IV in FIG. 3;

FIG. 5 is a cross-sectional perspective view around an other-side locking part, which is taken along IV-IV in FIG. 3;

FIG. 6 is a perspective view illustrating a bobbin according to the embodiment;

FIG. 7 is a perspective view illustrating a cover according to the embodiment;

FIG. 8 is a cross-sectional view taken along VIII-VIII in FIG. 1;

FIG. 9 is a perspective view illustrating a state before the cover is attached to the base member according to the embodiment;

FIG. 10 is a partially enlarged cross-sectional view corresponding to a cross section taken along X-X in FIG. 1, illustrating a state when the cover enters a cover guide part according to the embodiment;

FIG. 11 is a partially enlarged cross-sectional view corresponding to the cross section taken along X-X in FIG. 1, illustrating a state when the cover enters the cover guide part according to the embodiment and the cover further advances from FIG. 10; and

FIG. 12 is a partially enlarged cross-sectional view taken along X-X in FIG. 1, illustrating a state in which a cover side locking part is locked to a base side locking part according to the embodiment.

### DETAILED DESCRIPTION OF THE PREFERRED EMBODIMENTS

Embodiments according to the present invention will hereinafter be described in detail on the basis of the drawings. Note that the present invention is not limited by the embodiments. In addition, the components in the following embodiments include those that are substitutable and easily conceivable for persons who are skilled in the art, or those that are substantially the same.

### Embodiment

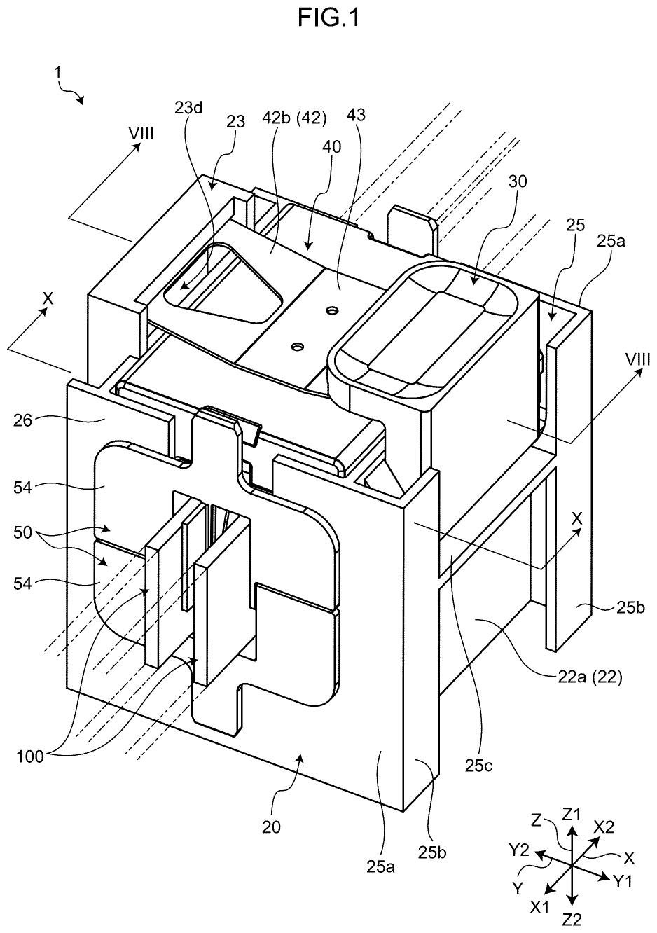

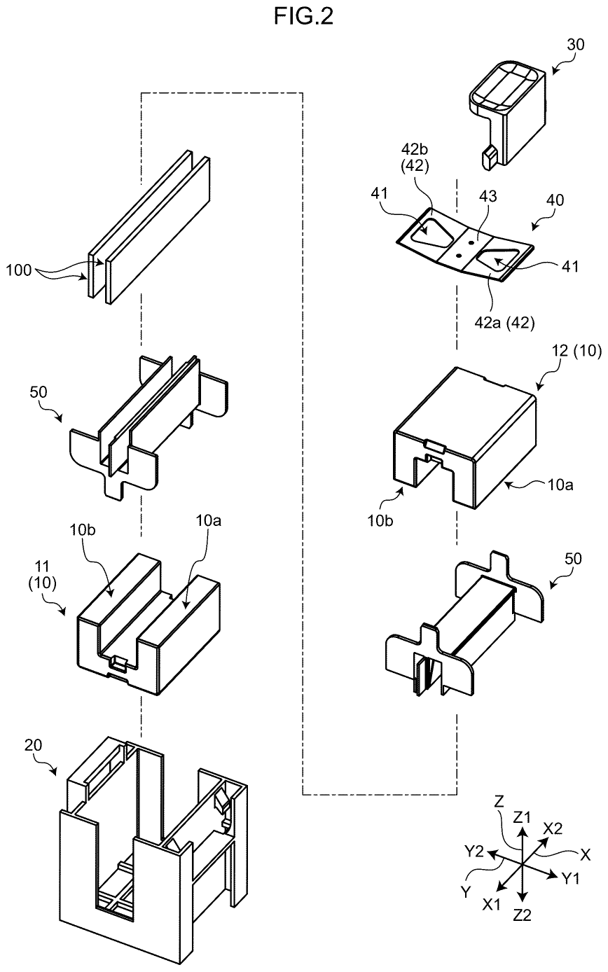

A magnetic unit 1 according to the embodiment illustrated in FIG. 1 and FIG. 2 is, for example, provided in a high-voltage junction box to which a high-voltage battery pack mounted in a vehicle, such as an electric vehicle or a hybrid vehicle, is electrically connected. In the magnetic unit 1, busbars 100 are inserted to a magnetic core 10 with an annular shape that includes split cores, that is, a first core 11 and a second core 12. The busbar 100 is a circuit body (conductor) that forms a high-voltage circuit system including a high-voltage battery pack and the like. The magnetic unit 1 including the magnetic core 10 can suitably remove high-frequency noise in the busbar 100 and suitably suppress surge voltages.

The magnetic unit 1 includes the magnetic core 10, a base member 20, a cover 30, a plate spring 40 as an energizing member, and two bobbins 50. Two busbars 100 are inserted to the magnetic core 10, which is formed in an annular shape. The busbar 100 is formed in a long shape, and is illustrated only partially in the drawing.

In the following description, an axial direction of the annular magnetic core 10 in which the two busbars 100 extend is a first direction X, and two directions that are orthogonal to the first direction X are a second direction Y and a third direction Z. The second direction Y is the direction in which the two busbars 100 are arranged. One side in the first direction X is described as one side X1 and the other side is described as the other side X2 below. Similarly, one side and the other side in the second direction Y are described as one side Y1 and the other side Y2 and one side and the other side in the third direction Z are described as one side Z1 and the other side Z2, respectively.

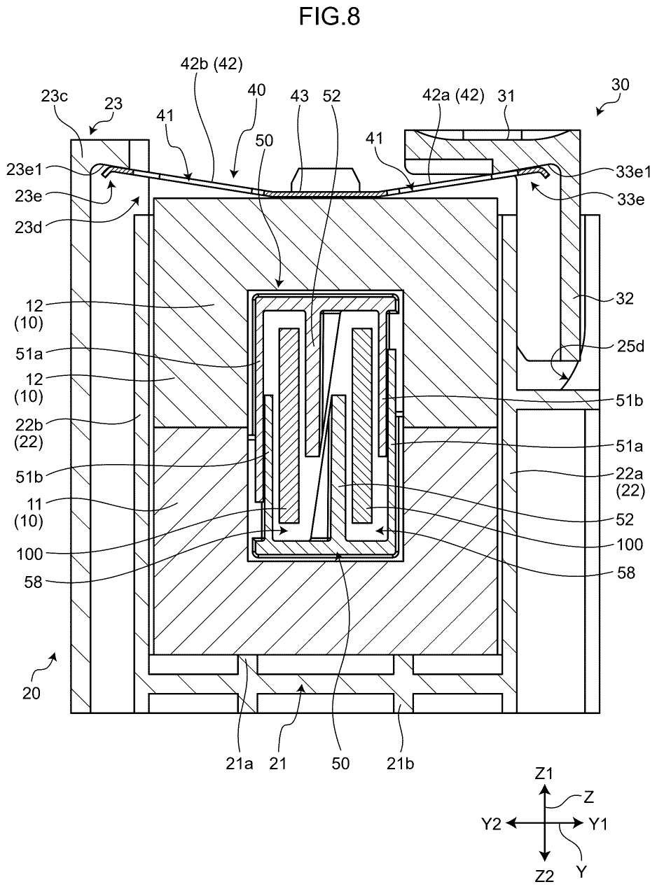

As illustrated in FIG. 2, the magnetic core 10 includes the first core 11 and the second core 12 split along the second direction Y. The magnetic core 10 is formed annularly about the first direction X with the first core 11 and the second core 12 combined (see also FIG. 8). The first core 11 and the second core 12 are formed in the same shape and are formed of a magnetic material such as ferrite. The first core 11 and the second core 12 have an approximately U-like shape as viewed from the first direction X, and are long along the first direction X. Of the first core 11 and the second core 12, two flat surfaces located on the open side of the approximately U-like shape are contact surfaces 10a and 10b. In the magnetic core 10, the respective contact surfaces 10a and 10b of the first core 11 and the second core 12 are in contact with each other along the third direction Z.

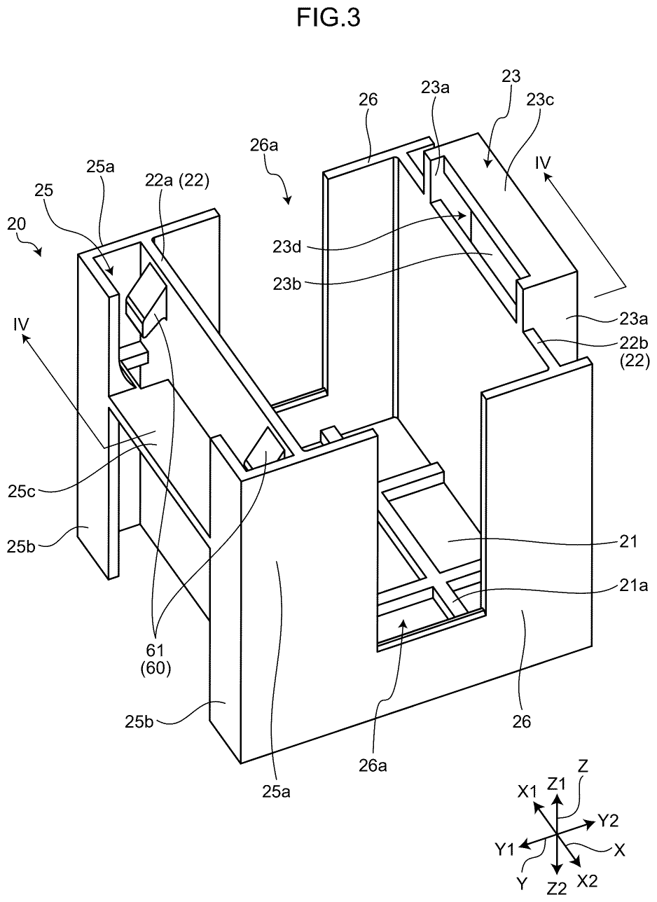

As illustrated in FIG. 3, the base member 20 is formed in an approximately cuboid box-like shape with an opening on one side Z1 in the third direction Z. The base member 20 has an approximately long rectangular plate-shaped bottom part 21 that is approximately parallel to a plane containing the first direction X and the second direction Y. On one side Z1 of the bottom part 21 in the third direction Z, a core support part 21a is formed in a grid pattern. A surface of the core support part 21a on one side Z1 in the third direction Z is in contact with, and supports the surface of the first core 11 on the other side Z2 in the third direction Z. As illustrated in FIG. 8, a rib 21b with the grid pattern similar to that of the core support part 21a is also formed at the bottom part 21 on the other side Z2 in the third direction Z.

As illustrated in FIG. 3, in the vicinity of an end part of the bottom part 21 on one side Y1 in the second direction Y and in the vicinity of an end part thereof on the other side Y2, two sidewall parts 22 rising toward one side Z1 in the third direction Z are provided. Here, the sidewall part 22 on one side Y1 in the second direction Y is a sidewall part 22a, and the sidewall part 22 on the other side Y2 is a sidewall part 22b. The sidewall parts 22a and 22b have an approximately plate-like shape with their plate surfaces facing in the second direction Y. The sidewall parts 22a and 22b are each located on the side of the magnetic core 10 in the second direction Y (see FIG. 8). At each end part of each of the sidewall parts 22a and 22b on one side X1 and the other side X2 in the first direction X, an insertion plate part 26 with an approximately plate-like shape is provided. Each of the insertion plate parts 26 is provided with a plate surface facing in the first direction X. Each of the insertion plate parts 26 has an insertion opening 26a that is long along the third direction Z at a substantial center in the second direction Y. The bobbin 50 is disposed in the insertion opening 26a and the busbar 100 is inserted therethrough.

On the outside of the sidewall part 22a on one side Y1 in the second direction Y, a cover guide part 25 and a base side locking part 61 are provided. The cover guide part 25 guides the cover 30 entering along the third direction Z. The cover guide part 25 includes guide side plates 25a extending from the insertion plate parts 26 on one side X1 and the other side X2 in the first direction X to one side Y1 in the second direction Y. The cover guide part 25 includes guide plates 25b. The guide plates 25b extend from the guide side plates 25a on one side X1 and the other side X2 in the first direction X so as to face each other along the first direction X. In other words, the guide plate 25b extends from the guide side plate 25a on one side X1 to the other side X2, and the guide plate 25b extends from the guide side plate 25a on the other side X2 to one side X1. The guide plates 25b on one side X1 and the other side X2 in the first direction X are separated from each other. Each of the guide side plates 25a and the guide plates 25b is formed in the same length in the third direction Z as the sidewall part 22. A lateral plate 25c is provided between the guide side plates 25a on one side X1 and the other side X2 in the first direction X, and also extends between the guide plates 25b on one side X1 and the other side X2 in the first direction X. The lateral plate 25c is provided with its plate surface facing in the third direction Z.

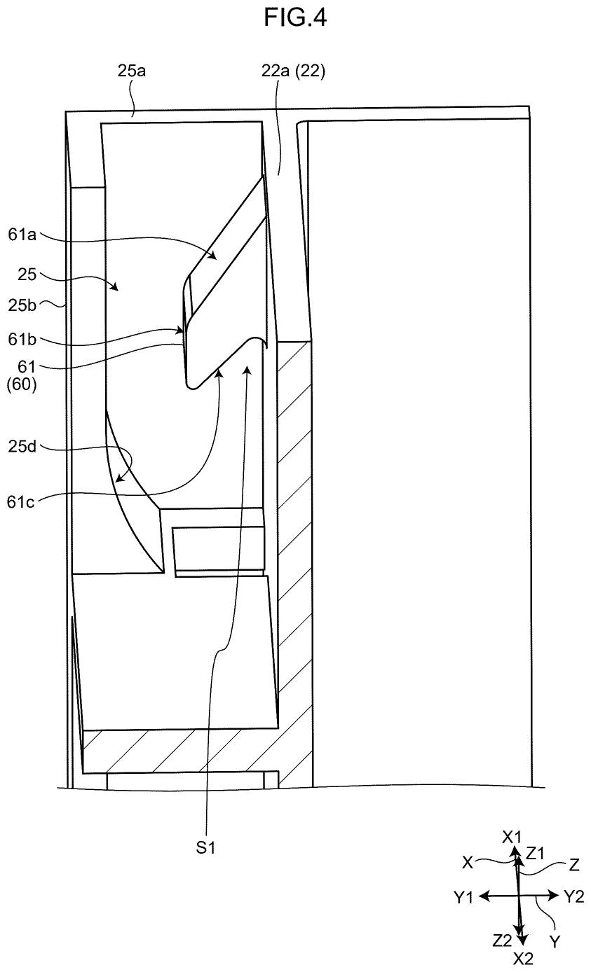

As illustrated in FIG. 4, a guide surface 25d is provided on a surface, in the surface of each guide plate 25b on the other side Y2 in the second direction Y, on the other side Z2 in the third direction Z. The guide surface 25d is provided on the outside of the sidewall part 22a in the second direction Y (one side Y1 in the second direction Y) so as to face the base side locking part 61. The guide surface 25d is formed by being curved so as to approach the base side locking part 61 gradually as getting toward the other side Z2 in the third direction Z.

The base side locking part 61 is locked with a cover side locking part 62 described below, so as to form a lock part 60 together with the cover side locking part 62. The base side locking part 61 is provided projecting from the sidewall part 22a to the outside and inclined toward the other side Z2 in the third direction Z (in other words, to a direction where the cover 30 will enter, which will be described below). The base side locking part 61 includes a first inclined surface 61a that is a surface on one side Z1 in the third direction Z and connects to the sidewall part 22a, a hanging surface 61b that is provided hanging from a tip end of the first inclined surface 61a to the other side Z2 in the third direction Z, and a second inclined surface 61c that connects the hanging surface 61b and the sidewall part 22a and is approximately parallel to the first inclined surface 61a. The base side locking part 61 is formed so that the angle between the hanging surface 61b and the second inclined surface 61c becomes acute through a rounded shape at the tip end. Between the sidewall part 22a and the other side Z2 of the base side locking part 61 in the third direction Z, a space S1 in which the cover side locking part 62 is locked is formed, which will be described below.

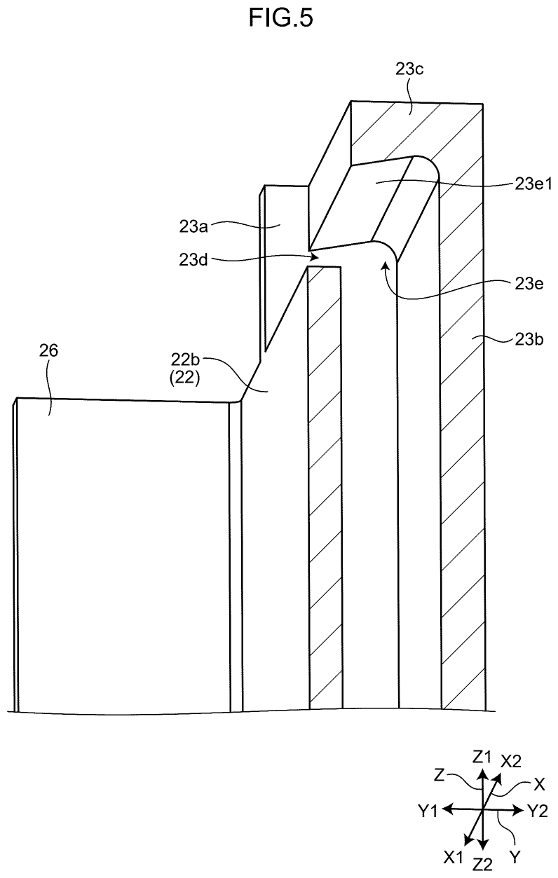

As illustrated in FIG. 3, a spring locking part 23 with an approximately long rectangular box shape that is long along the first direction X and the third direction Z is provided outside the sidewall part 22b on the other side Y2 in the second direction Y. A part of the spring locking part 23 on one side Z1 in the third direction Z projects to one side Z1 compared to an end part of the sidewall part 22b on one side Z1. The spring locking part 23 includes two side plates 23a provided from the sidewall part 22b to the outside so as to face each other in the first direction X. The two side plates 23a are disposed with their plate surfaces facing in the first direction X. On the other side Y2 in the second direction Y between the two side plates 23a, an outer plate 23b is provided with its plate surface facing in the second direction Y (also see FIG. 5). On one side Z1 in the third direction Z between the two side plates 23a, an upper plate 23c is provided with its plate surface facing in the third direction Z. A part of the upper plate 23c that is on the other side Z2 in the third direction Z and exists on one side Z1 compared to the sidewall part 22b corresponds to an insertion port 23d that opens.

As illustrated in FIG. 5, the upper plate 23c is formed so as to extend substantially at a right angle from a projecting end of the outer plate 23b to one side Y1 in the second direction Y. The other side Z2 of the upper plate 23c in the third direction Z corresponds to an other-side locking part 23e to which a leg part 42b (described below) of the plate spring 40 on the other side is locked. Regarding the other-side locking part 23e, a surface of the upper plate 23c on the other side Z2 in the third direction Z includes an inclined surface 23e1 directed to the other side Z2 toward a projecting end (an end part on one side Y1 in the second direction Y) of the upper plate 23c.

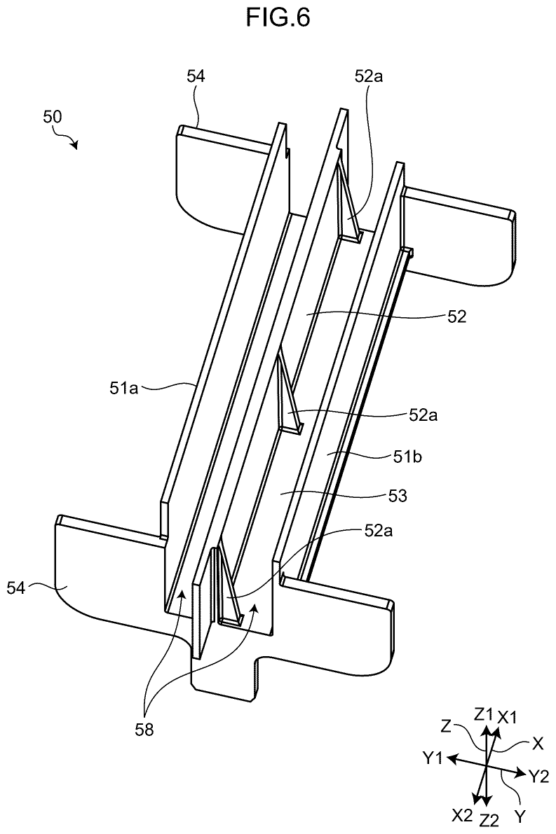

As illustrated in FIG. 2, the two bobbins 50 are provided facing each other along the third direction Z. Note that the two bobbins 50 are identical in shape. As illustrated in FIG. 6, the bobbin 50 includes two side plates 51a and 51b provided apart from each other, and a partition plate 52 provided between the two side plates 51a and 51b. Each of the side plates 51a and 51b and the partition plate 52 is formed in an approximately long rectangular shape that is long in the first direction X and has its plate surface facing in the second direction Y. Each of the side plates 51a and 51b and the partition plate 52 is connected by a bottom plate 53 at an end part in the third direction Z (end part on the other side Z2 in FIG. 6). The height, in the third direction Z, of the side plate 51a on one side Y1 in the second direction Y as illustrated in FIG. 6 is higher than that of the side plate 51b on the other side Y2 and the partition plate 52. On the other side Y2 of the partition plate 52 in the second direction Y, three ribs 52a that connect to the bottom plate 53 are provided. In each of the side plates 51a and 51b, a stop plate 54 is provided at each of end parts on one side X1 and the other side X2 in the first direction X. The stop plate 54 is provided with its plate surface facing in the first direction X. The stop plate 54 has an opening corresponding to the space between the side plates 51a and 51b and includes a part projecting to the outside of the side plates 51a and 51b.

The two bobbins 50 facing each other in the third direction Z are disposed inside the annular shape of the magnetic core 10, and busbar insertion paths 58 are formed on one side Y1 and the other side Y2 of the partition plates 52 in the second direction Y (see FIG. 8). Note that the partition plates 52 overlap with each other near the end part in the third direction Z. An inner side surface of the stop plate 54 of each bobbin 50 is close to, or in contact with an outer side surface of the insertion plate part 26 of the base member 20 (see FIG. 1).

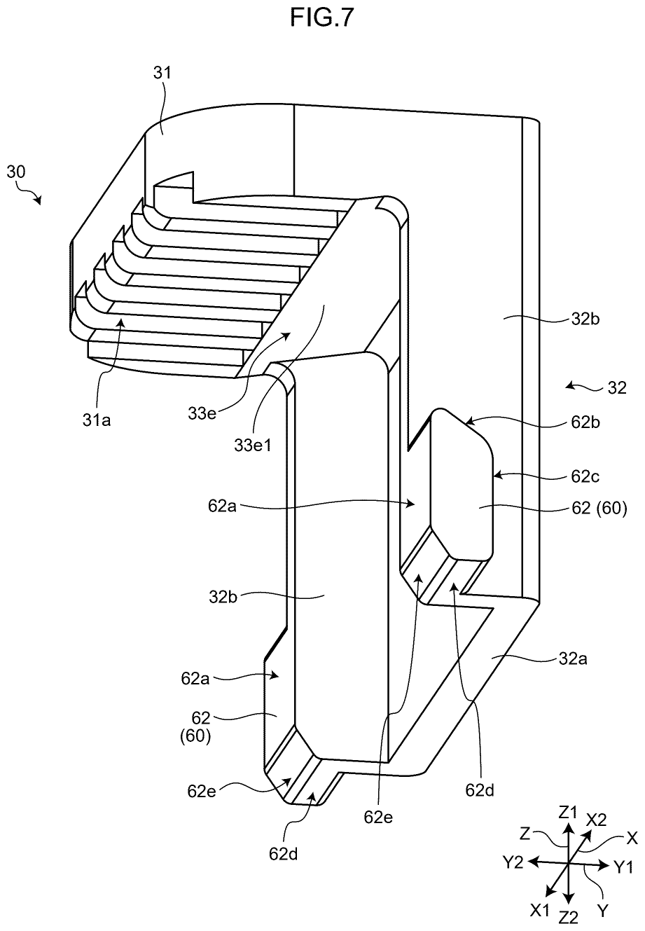

As illustrated in FIG. 7, the cover 30 is formed in an approximately L-like shape. The cover 30 includes a suppression part 31 that extends in an approximately plate-like shape in the second direction Y and an insertion part 32 that extends from the suppression part 31 along the third direction Z. A surface of the suppression part 31 on one side Z1 in the third direction Z has a depressed shape so that an operator can easily perform a pressing operation with his/her finger (see FIG. 1). On the other side Z2 of the suppression part 31 in the third direction Z, a plurality of grooves 31a extending along the second direction Y are provided. On one side Y1 in the second direction Y at the groove 31a of the suppression part 31 on the other side Z2 in the third direction Z, a one-side locking part 33e to which a leg part 42a of the plate spring 40 on one side is locked is provided. The one-side locking part 33e includes an inclined surface 33e1 to the other side Z2 in the third direction Z toward a projecting end of the suppression part 31 (also see FIG. 8).

The insertion part 32 includes a main plate 32a in a plate-like shape with its plate surface facing in the second direction Y, and two side plates 32b projecting to the other side Y2 in the second direction Y from both ends of the main plate 32a in the first direction X. The side plate 32b is disposed with its plate surface facing in the first direction X. On the two side plates 32b, a cover side locking part 62 projecting from an outer side surface of each side plate 32b is provided. The cover side locking part 62 includes a first hanging surface 62a that is a surface along the third direction Z and faces the other side Y2 in the second direction Y, a second hanging surface 62c that is a surface approximately parallel to the first hanging surface 62a and faces one side Y1 in the second direction Y, and an upward inclined surface 62b that connects between the first hanging surface 62a and the second hanging surface 62c on one side Z1 in the third direction Z. On the other side Z2 in the third direction Z, the cover side locking part 62 includes a horizontal surface 62d that is connected to the second hanging surface 62c and extends along the second direction Y, and a downward inclined surface 62e that connects between the horizontal surface 62d and the first hanging surface 62a. The cover side locking part 62 is formed so that the angle between the first hanging surface 62a and the upward inclined surface 62b becomes acute through a rounded shape at the tip end.

As illustrated in FIG. 2 and FIG. 8, the plate spring 40 is formed of a sheet metal material, includes two leg parts 42, and is formed in an approximately mountain-like shape. A projecting end of each leg part 42 is bent toward the other side Z2 in the third direction Z to form a curved shape. Of the two leg parts 42, the leg part 42 on one side Y1 in the second direction Y is the leg part 42a and the leg part 42 on the other side Y2 is the leg part 42b. The leg part 42 includes an opening 41 with an approximately triangular shape. The space between the leg parts 42 corresponds to a pressing part 43. The pressing part 43 is formed in parallel to a plane containing the first direction X and the second direction Y. The two leg parts 42 are inclined from the pressing part 43 toward one side Z1 in the third direction Z.

As illustrated in FIG. 8, the leg part 42a on one side of the plate spring 40 is locked to the one-side locking part 33e of the cover 30 while the cover 30 is in the state of being locked to the base member 20. Specifically, when a surface of the leg part 42a on one side Z1 in the third direction Z is in contact with the inclined surface 33e1 of the one-side locking part 33e, the leg part 42a is locked to the one-side locking part 33e. In addition, the leg part 42b of the plate spring 40 on the other side is locked to the other-side locking part 23e provided at the base member 20. Specifically, when a surface of the leg part 42b on one side Z1 in the third direction Z is in contact with the inclined surface 23e1 of the other-side locking part 23e, the leg part 42b is locked to the other-side locking part 23e. Since the leg part 42 of the plate spring 40 with an approximately mountain-like shape is in surface contact with the inclined surfaces 33e1 and 23e1 and is locked thereby, the plate spring 40 can be locked for sure. In this manner, both ends of the plate spring 40 in the second direction Y are suppressed; therefore, the elastic force is generated in the plate spring 40. The plate spring 40 having the elastic force energizes the second core 12 toward the first core 11 along the third direction Z with the pressing part 43 that is in contact with the surface of the second core 12 on one side Z1 in the third direction Z. In this manner, the magnetic core 10 is held in the magnetic unit 1.

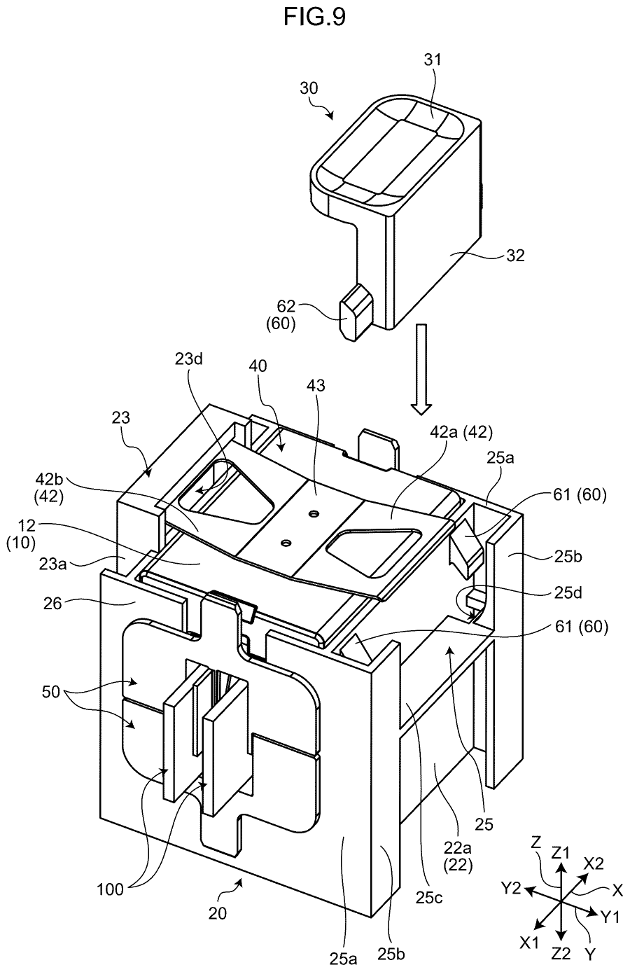

The plate spring 40 is assembled as follows. As illustrated in FIG. 9, first, the first core 11, the bobbins 50, and the second core 12 are accommodated in the base member 20. Briefly speaking, the first core 11 with the contact surface 10a, 10b side oriented to one side Z1 in the third direction Z is accommodated in the base member 20. Then, the first core 11 is supported by the bottom part 21 (the core support part 21a) of the base member 20. After that, the two bobbins 50 are disposed on the first core 11 and the second core 12 is accommodated in the base member 20 so that the second core 12 and the first core 11 are in contact with each other. Then, the busbar 100 is inserted to each of the two busbar insertion paths 58 formed by the bobbins 50, which are arranged facing each other.

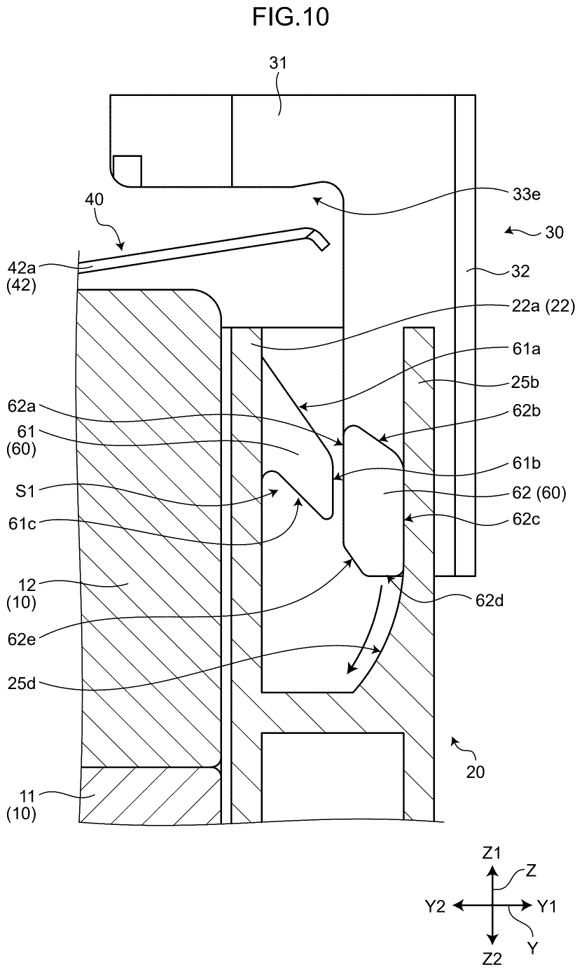

In the plate spring 40, the leg part 42b of the plate spring 40 on the other side Y2 in the second direction Y is inserted to the insertion port 23d of the spring locking part 23 of the base member 20, thereby locking the other-side locking part 23e of the base member 20 and the leg part 42b of the plate spring 40. At this time, the pressing part 43 of the plate spring 40 and the surface of the second core 12 on one side Z1 in the third direction Z are in contact with each other. The cover 30 is moved to the other side Z2 along the third direction Z to make the insertion part 32 enter the cover guide part 25. Specifically, the insertion part 32 is inserted between the guide plates 25b so that the cover 30 enters the base member 20 in such a way that the second hanging surface 62c of the cover side locking part 62 extends along the inner side surface of the guide plate 25b (see FIG. 10).

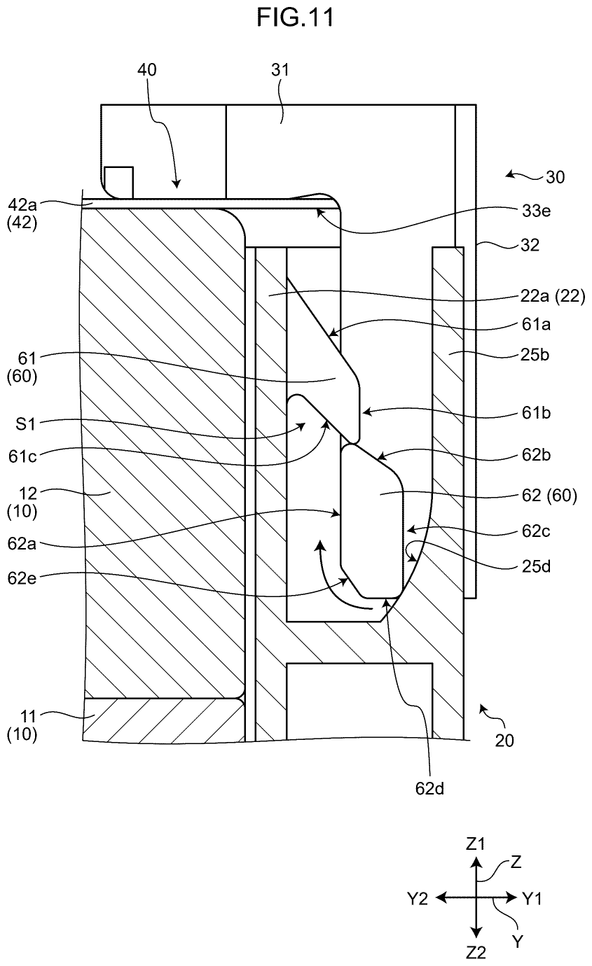

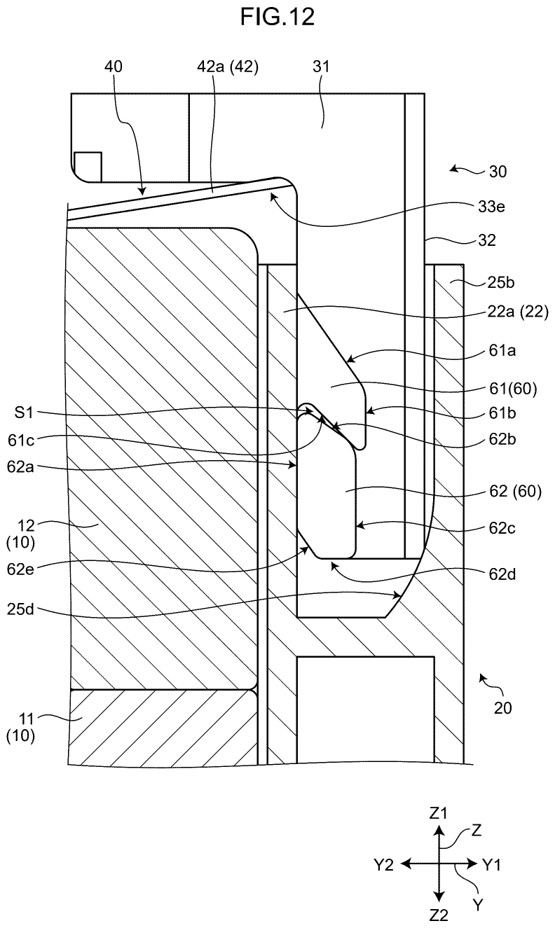

The cover 30 that enters the cover guide part 25 is guided as the second hanging surfaces 62c of the two cover side locking parts 62 of the insertion part 32 are in slide contact with the inner side surfaces (surfaces on the other side Y2) of the guide plates 25b as illustrated in FIG. 10. Then, further pushing the cover 30 so as to push the surface of the cover 30 on one side Z1 in the third direction Z causes a corner part where the second hanging surface 62c of the cover side locking part 62 and the horizontal surface 62d connect to each other to be in slide contact with the guide surface 25d. Therefore, the cover side locking part 62 is guided to the direction of approaching the sidewall part 22 of the base member 20 along the guide surface 25d. At this time, as illustrated in FIG. 11, a projecting end of the cover side locking part 62 moves to the sidewall part 22 side compared to a projecting end of the base side locking part 61. In addition, at this time, the leg part 42a of the plate spring 40 is locked to the one-side locking part 33e. Since the leg part 42b of the plate spring 40 on the other side is locked, the leg part 42a of the plate spring 40 on one side energizes the cover 30 to one side Z1 in the third direction Z. Accordingly, when the hand that has pushed in the cover 30 is removed, for example, the cover 30 moves to one side Z1 in the third direction Z as illustrated in FIG. 12. At this time, the upward inclined surface 62b of the cover side locking part 62 and the second inclined surface 61c of the base side locking part 61 are in slide contact with each other and the cover side locking part 62 enters the space S1 between the base side locking part 61 and the sidewall part 22 and is locked. By the slide contact between the inclined surfaces (the upward inclined surface 62b of the cover side locking part 62 and the second inclined surface 61c of the base side locking part 61), the cover side locking part 62 is locked with the base side locking part 61 smoothly. In this manner, the lock part 60 including the base side locking part 61 and the cover side locking part 62 locks the cover 30 and the base member 20 to each other.

The magnetic unit 1 described above includes: the magnetic core 10 formed in the annular shape about the first direction X and including the first core 11 and the second core 12 split along the second direction Y that intersects with the first direction X, in which the first core 11 and the second core 12 are in contact with each other along the third direction Z that intersects with the first direction X and the second direction Y; the plate spring 40 corresponding to the energizing member configured to energize the second core 12 toward the first core 11 along the third direction Z; the cover 30 including the one-side locking part 33e to which one side (leg part 42a) of the plate spring 40 is locked; the base member 20 that accommodates the magnetic core 10 and includes the bottom part 21 that supports the first core 11, the cover guide part 25 that guides the cover 30 entering along the third direction Z, and the other-side locking part 23e to which the other side (leg part 42b) of the plate spring 40 is locked; and the lock part 60 that locks the cover 30 and the base member 20 to each other.

In this manner, in the magnetic unit 1 according to this embodiment, the plate spring 40 can be assembled by a simple work of attaching the cover 30 to the base member 20 by pushing in the cover 30 with the leg part 42b of the plate spring 40 on the other side hooked to the other-side locking part 23e. Therefore, the plate spring 40, which is the energizing member to energize the magnetic core 10, can be assembled properly.

For example, in the case of assembling the plate spring 40 with a cover that covers the plate spring 40 instead of the cover 30 according to this embodiment, sub-assembling of attaching the plate spring 40 to the cover before the cover is attached to the base member may be necessary. The cover 30 according to this embodiment eliminates the necessity of such sub-assembling; therefore, the assembling workability of the plate spring 40 can be improved. In addition, the cover 30 according to this embodiment keeps the lock part 60 locked with the repulsive force of the plate spring 40; therefore, the detachment of the lock part 60 (the cover side locking part 62) or the displacement of the cover side locking part 62 due to vibration or the like can be reduced and the magnetic core 10 can be kept in contact stably. Thus, the high-frequency noise removing performance and the surge voltage reduction can be kept stably. Furthermore, the volume of the cover 30 can be made smaller than that of the cover formed so as to cover the plate spring 40; therefore, the amount of resin material necessary to manufacture the cover 30 can be reduced, for example.

Moreover, the cover 30 includes the suppression part 31 that extends along the second direction Y and includes the one-side locking part 33e, and the insertion part 32 that extends along the third direction Z from the suppression part 31 and is inserted to the cover guide part 25, and the lock part 60 includes the base side locking part 61 that is provided in the base member 20 and the cover side locking part 62 that is provided in the insertion part 32 and locked to the base side locking part 61. Thus, the mode of the cover 30 can be formed into an approximately L-like shape including the suppressing part 31 and the insertion part 32, which facilitates the pressing operation of pressing the suppression part 31.

Additionally, the base side locking part 61 projects outward from the sidewall part 22 provided on the side of the magnetic core 10 in the second direction Y and is provided with inclination to the direction in which the cover 30 enters, the cover side locking part 62 is provided projecting from the insertion part 32 along the first direction X and locked on the side of the sidewall part 22 of the base side locking part 61, the cover guide part 25 includes the guide surface 25d that guides the cover side locking part 62, and the guide surface 25d is provided facing the base side locking part 61 outside the sidewall part 22 in the second direction Y and is curved so as to gradually approach the base side locking part 61. This enables the lock part 60 to lock so that the cover side locking part 62 enters the space S1 inside the inclined base side locking part 61, which makes it difficult to detach the cover side locking part 62. In the space S1, the second inclined surface 61c and the outer side surface of the sidewall part 22a are connected to each other at an acute angle and the acute projecting end part of the cover side locking part 62 enters; therefore, a wedge effect is exhibited and the extraction becomes difficult. The cover 30 can be locked to the base member 20 with the simple operation of canceling the pressing operation of the cover 30 by the guide surface 25d also serving as a cam surface with the cover side locking part 62 serving as a follower.

The magnetic unit according to any of the embodiments of the present invention described above is not limited to the embodiment described above, and various changes can be made within the scope of the claims.

Although the plate spring 40 is used as the energizing member that energizes the second core 12, another energizing member can also be used. Although the lock part 60 is configured by the base side locking part 61 and the cover-side locking part 62, another configuration of locking the cover 30 and the base member 20 to each other can also be employed.

The magnetic unit according to this embodiment may be configured by combining the components in the embodiments and modifications described above as appropriate.

The magnetic unit according to the present embodiment has the effect that the energizing member to energize the magnetic core can be properly assembled.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic unit comprising:
a magnetic core formed in an annular shape about a first direction and including a first core and a second core split along a second direction that intersects with the first direction, in which the first core and the second core are in contact with each other along a third direction that intersects with the first direction and the second direction;
an energizing member configured to energize the second core toward the first core along the third direction;
a cover including a one-side locking part to which one side of the energizing member is locked;
a base member that accommodates the magnetic core and includes a bottom part that supports the first core, a cover guide part that guides the cover entering along the third direction, and an other-side locking part to which the other side of the energizing member is locked; and
a lock part that locks the cover and the base member to each other.

2. The magnetic unit according to claim 1, wherein
the cover includes a suppression part that extends along the second direction and includes the one-side locking part, and an insertion part that extends along the third direction from the suppression part and is inserted to the cover guide part, and
the lock part includes a base side locking part that is provided in the base member and a cover side locking part that is provided in the insertion part and locked to the base side locking part.

3. The magnetic unit according to claim 2, wherein
the base side locking part projects outward from a sidewall part provided on a side of the magnetic core in the second direction and is provided with inclination to a direction in which the cover enters,
the cover side locking part is provided projecting from the insertion part along the first direction and locked on a side of the sidewall part of the base side locking part,
the cover guide part includes a guide surface that guides the cover side locking part, and
the guide surface is provided facing the base side locking part outside the sidewall part in the second direction and is curved so as to gradually approach the base side locking part.
